(19) United States
(12) Patent Application Publication
(10) Pub. No.: US 2024/0281989 A1
(43) Pub. Date: Aug. 22, 2024

(54) SYSTEMS AND METHODS OF IMAGE PROCESSING AND RENDERINGS THEREOF

(71) Applicant: Adam Kafka, Toronto (CA)

(72) Inventor: Adam Kafka, Toronto (CA)

(21) Appl. No.: 18/291,774

(22) PCT Filed: Jul. 29, 2022
(86) PCT No.: PCT/CA2022/051166

§ 371 Date: Jan. 24, 2024

Related U.S. Application Data
(60) Provisional application No. 63/330,951, filed on Apr. 14, 2022.
(60) Provisional application No. 63/227,071, filed on Jul. 29, 2021.

(51) Int. Cl. G06T 7/50; G06T 5/73; G06T 5/77; G06T 7/11; G06T 7/13; G06V 10/56

(52) U.S. Cl. CPC G06T 7/50; G06T 5/73; G06T 5/77; G06T 7/11; G06T 7/13; G06V 10/56; G06V 2201/07

(57) ABSTRACT

There is disclosed herein systems and methods of image processing including obtaining an original image (OI): generating an image depth map (IDM): converting the IDM to greyscale colouring: sharpening resolution of the ID.M: posterizing the IDM where to a number of levels wherein the number is a final layer count (FLC): splitting the IDM based on the FLC: clipping the OI into a plurality of clips based on the split ID.M: producing an infill/outfill between adjacent ones of the clips based on preceding clips in a production order: determining a number of retained pixels: printing each of the clips on a medium: assembling the clips in an order. Also disclosed herein are products produced according to the method disclosed herein and systems for conducting methods as disclosed herein.

### CROSS-REFERENCE TO RELATED APPLICATIONS

The present application claims priority to U.S. Provisional Patent Application Nos. 63/227,071 filed on 29 Jul. 2021 and 63/330,951 filed on 14 Apr. 2022, the contents of which two Provisional Patent Applications are hereby incorporated herein by reference in their entireties.

### FIELD

The present disclosure relates to digital processing of images, and renderings made therefrom including without limitation layered products giving or having an enhanced appearance.

### BACKGROUND

Digital image capturing has exploded with the proliferation of, among other things, increasingly high-resolution cameras. These are available not just to professional photographers but also to users of commonly owned phones incorporating such cameras. In either case, imagery is available at incredibly and increasingly vivid levels.

Such imagery is given to creation of rendered embodiments beyond conventional 2-dimensional prints. It is not common to see provided renderings of photographic layers, be it in printed embodiments or otherwise. While it is known to provide single layered media with artwork (e.g., painted, etched, etc.) on substantially parallel surfaces, such would be distinct from, for example and without limitation, multi-layered renderings having and giving the appearance of 3-dimensionality.

Known systems and methods of creating 3-dimensional renderings or products from 2-dimensional images are largely manually conducted, and do not provide for resulting products having the appearance of substantial 3-dimensionality. Each layer of known multi-layer renderings must be separated manually and a user would have to, for example and without limitation, paint each layer manually, or digitally separate the layers by manually indicating what needs to be separated, on a node by node basis, and then navigating photo editing or similar graphics software to separate it onto individual layers. Then, either manually or via import to 3-dimensional software to calculate a parallax created by the depth of medium (e.g., acrylic, glass, resin) in use, to provide a visualization of the product prior to its physical creation. Such methods require high levels of user skill, practice and are time-consuming.

For example, hand painted embodiments obviously require that skill set. Further, many individuals do not accurately perceive depth from a 2-dimensional image file, which makes it far more difficult for such persons to complete processes such as those background ones discussed above. Further still, many image processing software products are either rarely had or involve a significantly steep learning curve. This limits the ability of users to edit imagery and separate into layers needed for 3-dimensional renderings thereof.

Even once layers on an image are separated, there is no reliable automated or significantly electronically assisted means of laying out the layers to facilitate automated rendering of end products featuring the same.

As such, there is a need for systems, methods and/or end products related thereto that eliminate and/or mitigate one or more of the issues described above.

### BRIEF SUMMARY

There is disclosed herein methods of image processing including obtaining an original image (OI); generating an image depth map (IDM), in instances where not embedded in the OI; converting the IDM to predefined layer coloring such as grayscale; sharpening resolution of the IDM; posterizing the IDM where to a number of levels wherein the number is a final layer count (FLC); splitting the IDM based on the FLC; clipping the OI into a plurality of clips based on the split IDM; producing an infill/outfill between adjacent ones of the clips based on preceding clips in a production order; detecting one or more objects within the OI; detecting one or more edges within the OI; extracting from the OI one or more objects; determining a number of retained pixels; printing each of the clips on a medium, wherein one of the clips comprises one of the objects; assembling the clips in an order.

Also disclosed herein are methods wherein the detecting one or more objects and the detecting one or more edges may be conducted in alternate orders or one or the other omitted, depending on one or more properties of the original image.

Also disclosed herein are methods wherein the order comprises all or a subset of the clips.

Also disclosed herein are methods wherein the obtaining comprises input from a user.

Also disclosed herein are methods wherein the step of generating an image depth map, sharpening, splitting and posterizing thereof is omitted.

Also disclosed herein are methods wherein the obtaining comprises retrieval from electronic storage media.

Also disclosed herein are methods wherein the obtaining comprises capturing the OI via an image capture device.

Also disclosed herein are methods wherein the image capture device comprises a digital camera.

Also disclosed herein are methods wherein the digital camera is integrated with a processing device.

Also disclosed herein are methods wherein one or more dimensions of the OI and IDM are substantially equal.

Also disclosed herein are methods wherein the generating comprises extraction via the processing device; or, using an artificial intelligence system (AI) to create the IDM.

Also disclosed herein are methods wherein the FLC comprises in excess of 2 layers.

Also disclosed herein are methods wherein the FLC comprises in excess of 3 layers.

Also disclosed herein are methods wherein the FLC comprises in excess of 10 layers.

Also disclosed herein are methods wherein the FLC comprises in excess of 15 layers.

These methods apply where a maximum layer count may only be limited by the count of pixel color differential in the IDM

Also disclosed herein are methods wherein the producing is conducted via a further artificial intelligence processor.

Also disclosed herein are methods wherein the further artificial intelligence processor comprises the artificial intelligence processor.

[symbol] disclosed herein are methods wherein the medium comprises one or more of paper, cardboard, wood, metal, glass, silicone, acrylic and/or one or more materials susceptible of being laser cut.

Also disclosed herein are produced according to the method disclosed herein.

Also disclosed herein are systems for conducting methods as disclosed herein.

### BRIEF DESCRIPTION OF THE DRAWINGS

FIG. 1 is a schematic depiction of original image compared to rendered article;

FIG. 2. a left side view of a prior art product and a rendered article;

[symbol] 3A a schematic depiction of different methods of object detection; . . .

FIG. 3B is a depiction of edge and other detection of various objects in original images;

FIG. 4 is a schematic depiction of facial feature detection;

FIG. 5 is a schematic and comparative depiction of a trio of image effects and a processed version thereof;

FIG. 6A is a depiction of various features detected in original images;

FIG. 6B is a comparative depiction of detection clarity compared to prior art;

FIG. 6C is a further comparative depiction;

FIG. 7 is a schematic depiction of separation of objects from an original image;

FIG. 8 is a further depiction of the original image of FIG. 7;

FIG. 9 is a depiction of a processed original image;

FIG. 10 is a depiction of the layers comprising the processed image of FIG. 9;

FIG. 11 is a depiction of separated layers of an original image;

FIG. 12 is an original image;

FIG. 13 is a depth map of the original image of FIG. 12;

FIG. 14 is a split image depth map of the original image of FIG. 12;

FIG. 15 is a split image depth map of the original image of FIG. 12;

FIG. 16 is a further split image depth map of the original image of FIG. 12;

FIG. 17 is a clipped original image constructed from the original image of FIG. 12;

FIG. 18 is an exploded view of the clipped original image constructed from the original image of FIG. 12;

FIG. 19 is further clipped original image constructed from the original image of FIG. 12;

FIG. 20 is an exploded view of image clips from the original image of FIG. 12;

FIG. 21 is image clips and an assembled set thereof from the original image of FIG. 12;

FIG. 22 is image clips from the original image of FIG. 12 shown in an assembled configuration;

FIG. 23 is a simplified depiction of deconstruction of the original image of FIG. 12;

FIG. 24 is a two-layer segmentation of an original image;

FIG. 25 is a three-layer segmentation of an original image; and,

FIG. 26 is a five-layer segmentation of an original image.

### DETAILED DESCRIPTION

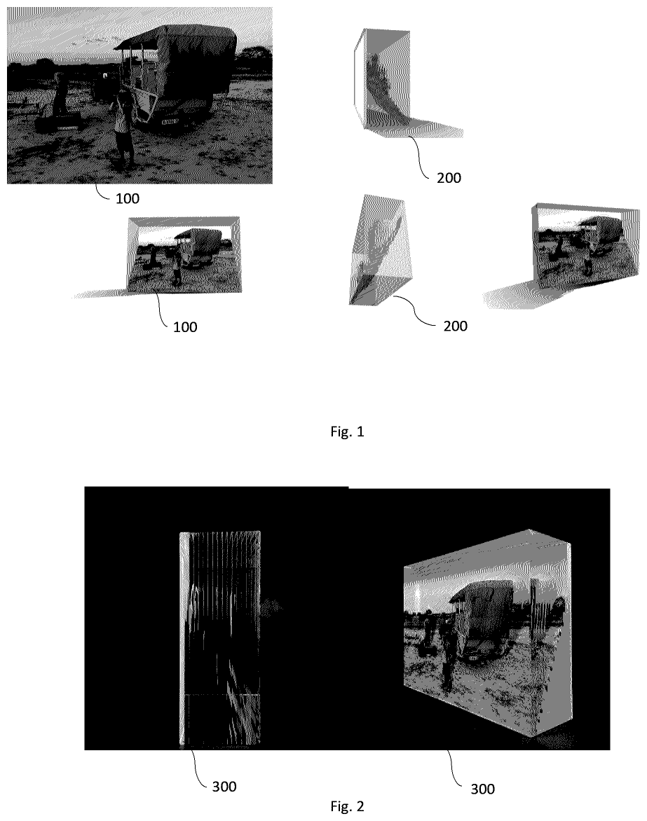

FIG. 1 shows an original image 100 compared to rendered article 200.

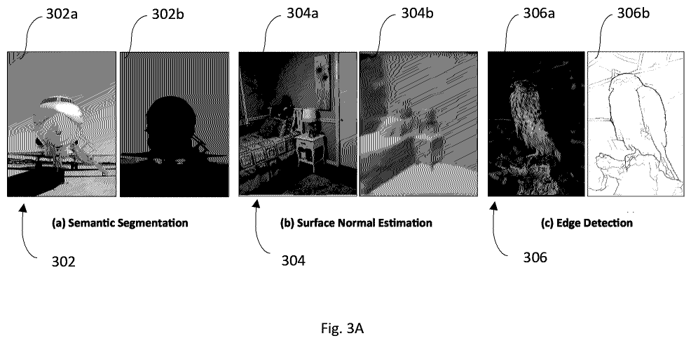

FIG. 2. a left side view of rendered article 300.

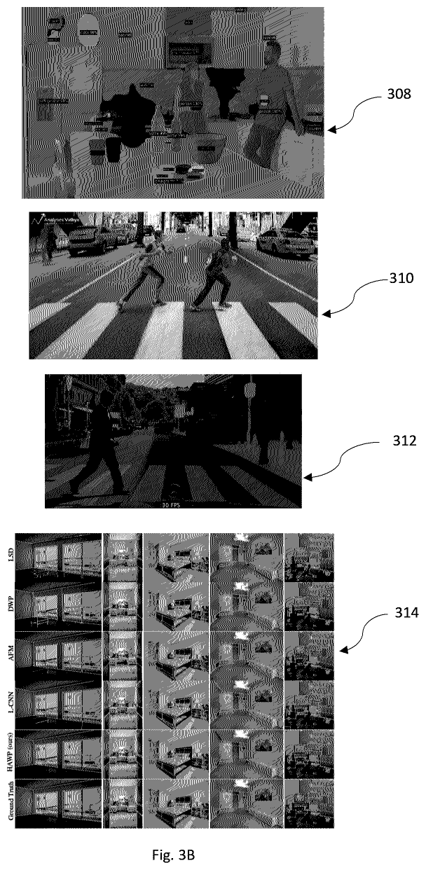

FIG. 3A a schematic depiction of different methods (302, 304, 306) of object detection.

FIG. 3B is a depiction of edge and other detection of various objects in original images (308, 310, 312).

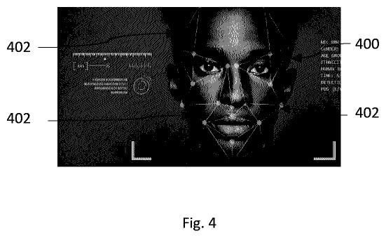

FIG. 4 is a schematic depiction of facial feature detection wherein a face 400 is shown as broken down into a plurality of segments 402.

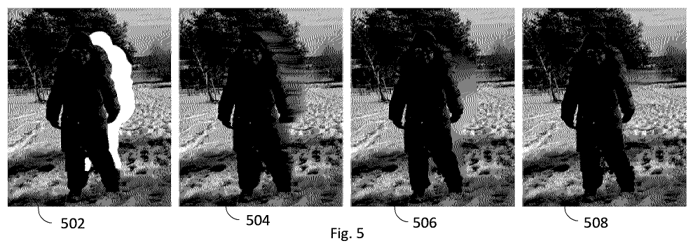

FIG. 5 is a schematic and comparative depiction of a quartet of image effects (500, 502, 504) and a processed version thereof. Image 508 notably includes none of the obscured traits of 502, 504, 506.

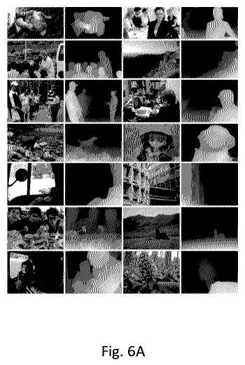

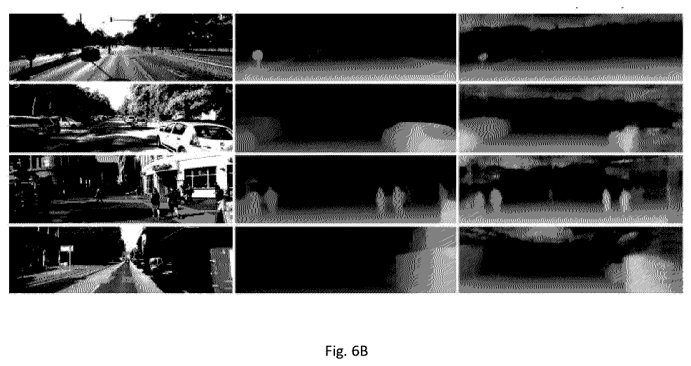

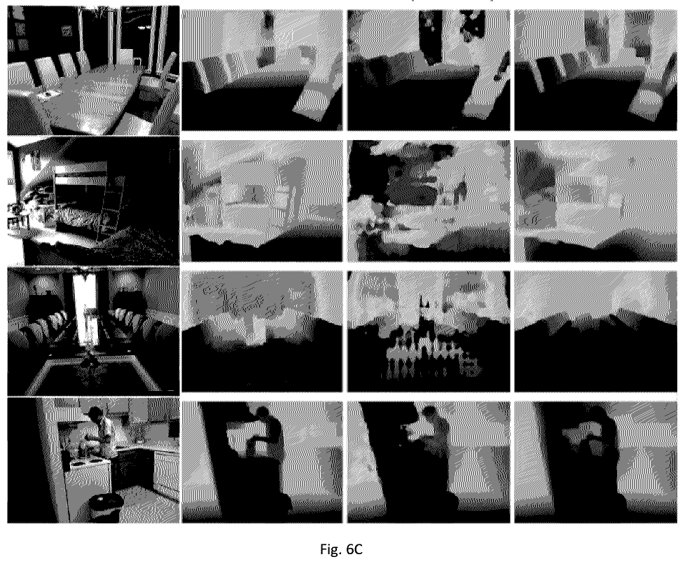

FIG. 6A is a depiction of various features (601, 603, 605, 607, 609, 611, 613, 615, 617, 619, 621, 623, 625, 627) detected in original images (602, 604, 606, 608, 610, 612, 614, 616, 618, 620, 622, 624, 626) and highlighting depictions of depth in such original images.

FIG. 6B is a comparative depiction of detection clarity compared to prior art, and FIG. 6C is a further such comparative depiction.

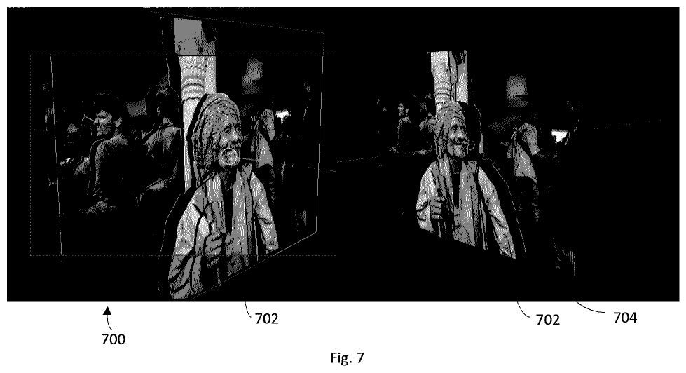

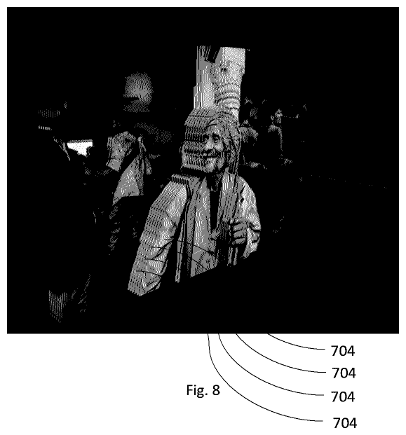

FIG. 7 is a schematic depiction of separation of objects (702) from a further original image 700, and lays 704 thereof. FIG. 8 is a further depiction of the original image 700 of FIG. 7 wherein additional separation between layers 704 is apparent.

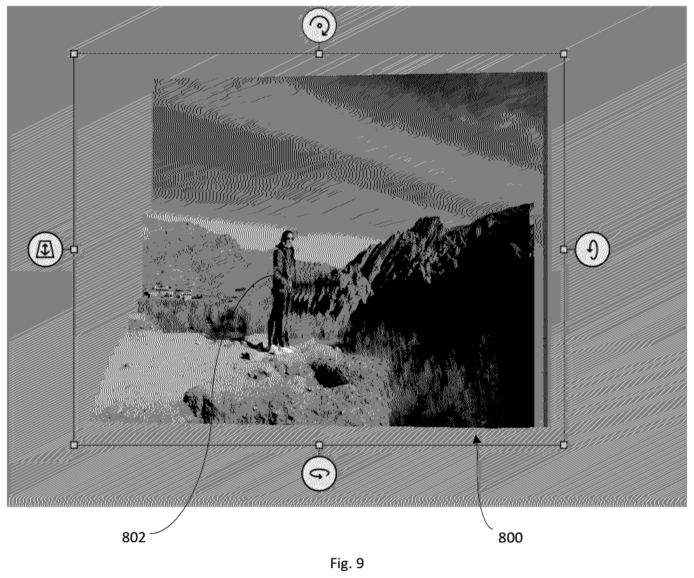

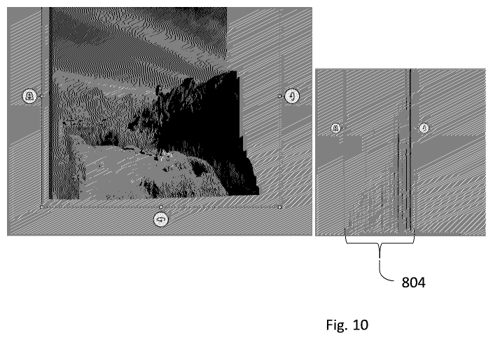

FIG. 9 is a depiction of a processed original image 800 wherein a central object 802 is most apparent. FIG. 10 is a depiction of the layers comprising the processed original image 800 of FIG. 9;

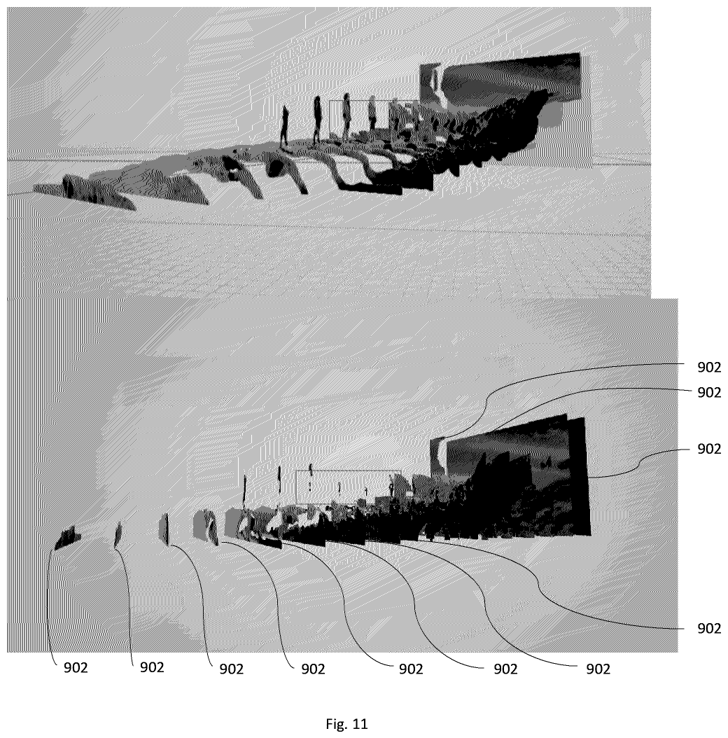

FIG. 11 is a depiction of separated layers 902 of an original image 900.

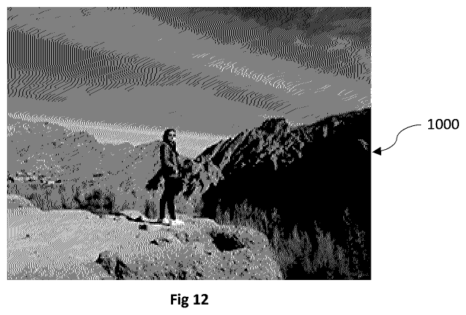

FIG. 12 is another original image 1000.

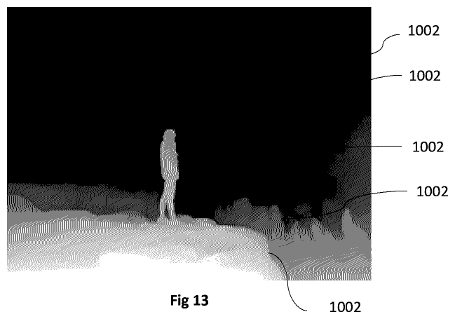

FIG. 13 is a depth map showing various objects 1002 comprising the original image 1000 of FIG. 12.

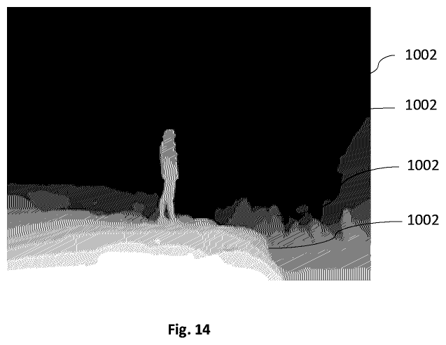

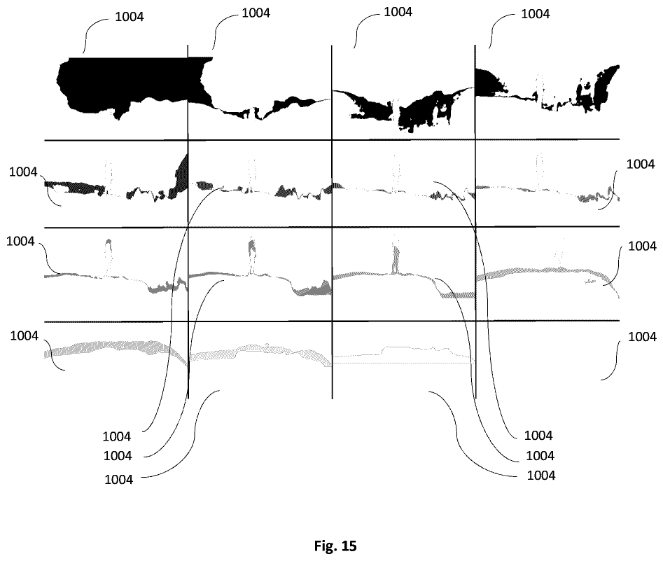

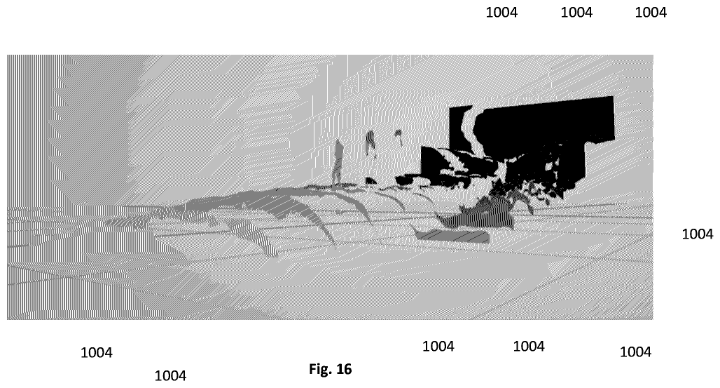

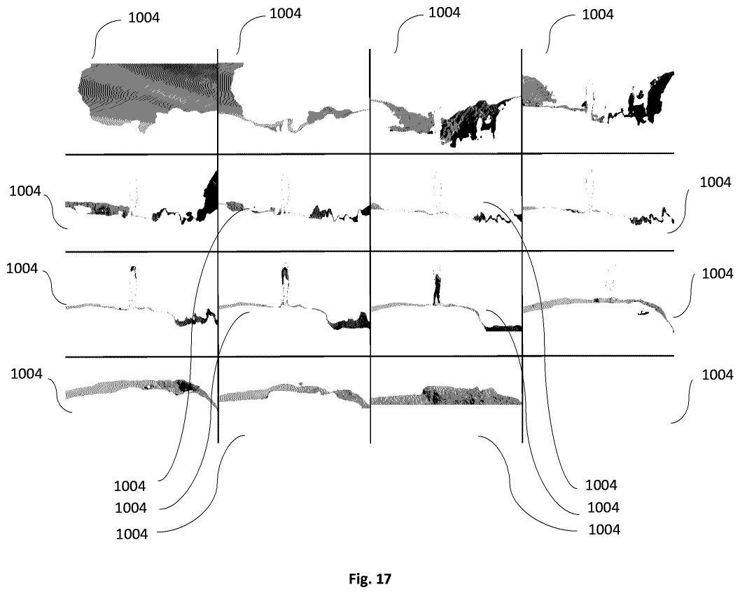

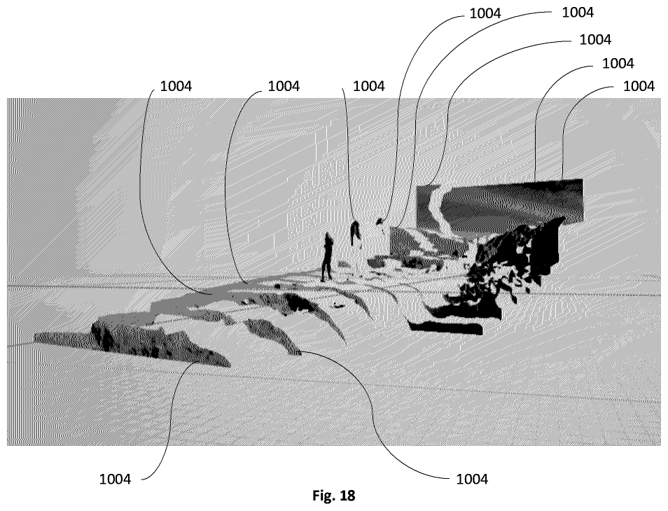

FIG. 14 is a split image depth map of the original image 1000 depicting objects 1002 in a split fashion. In FIG. 15, the objects 1002 have been separate in image layers 1004. In FIG. 16, the layers 1004 have been arranged in a sequence to depict the prominence and relative position of each in a final article to be constructed. FIG. 17 depicts further distinguished and clipped layers 1004 of the original image 1000. The depiction in FIG. 17 is shown as exploded view in FIG. 18 to highlight relative positioning of layers 1004.

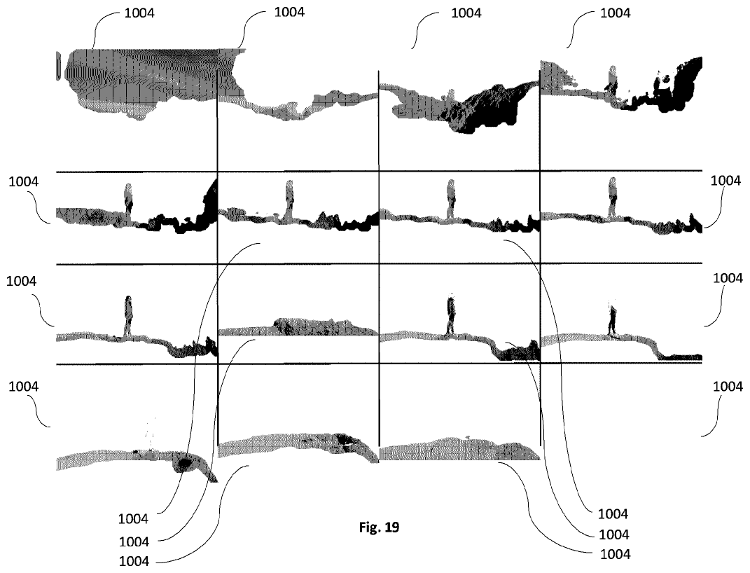

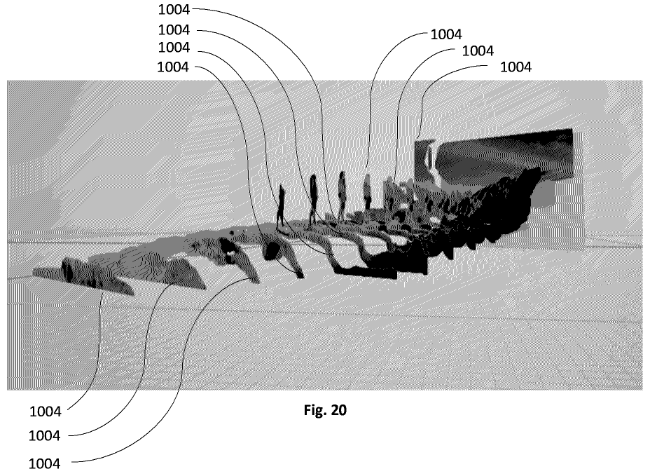

FIG. 19 is further clipped original image constructed from the original image 1000 and FIG. 20 is an exploded view thereof showing layers 1004 of the same.

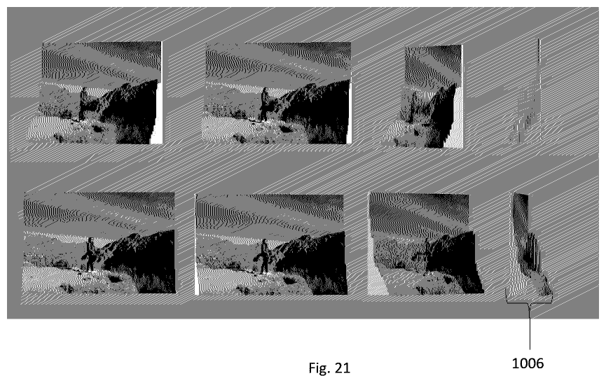

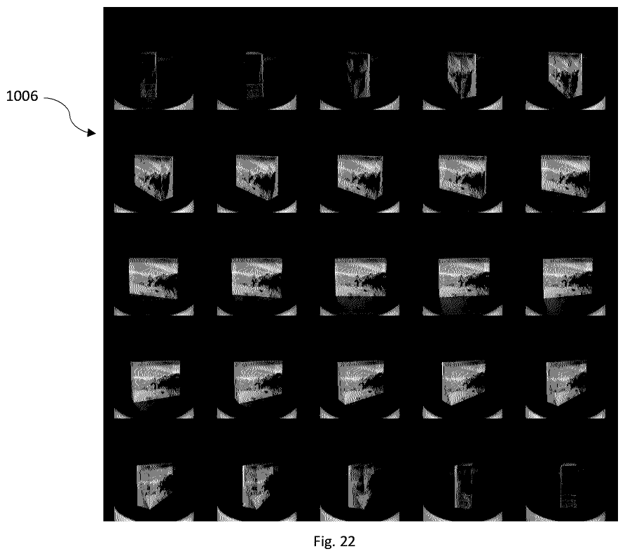

FIG. 21 shows image clips 1006 of the original image 1000 in an assembled configuration A depicting their relative arrangement and giving a 3-dimensional effect. FIG. 22 is image clips 1006 from the original image 1000 of FIG. 12 shown in an assembled configuration A.

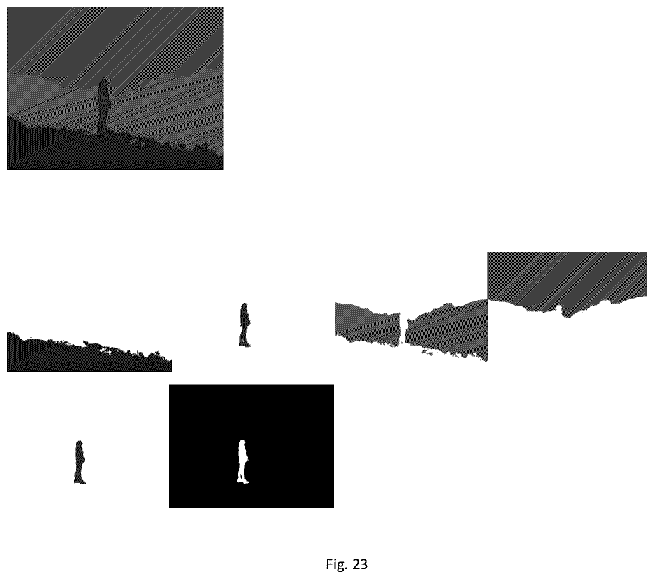

FIG. 23 is a simplified depiction of deconstruction of the original image 1000 of FIG. 12;

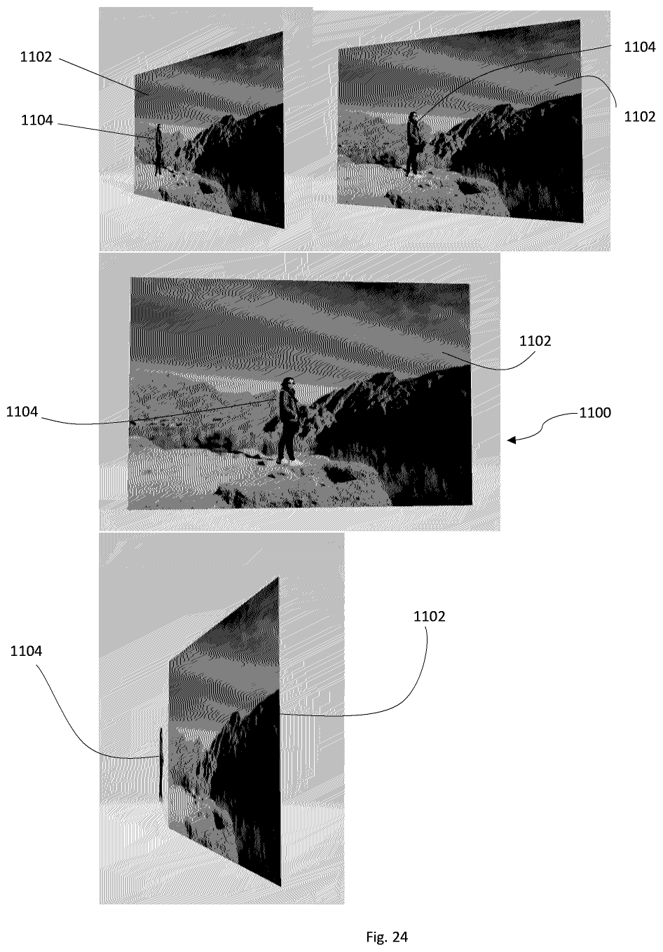

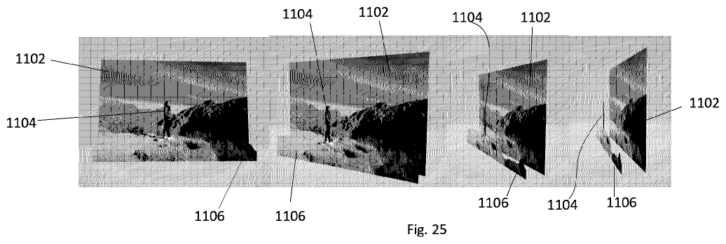

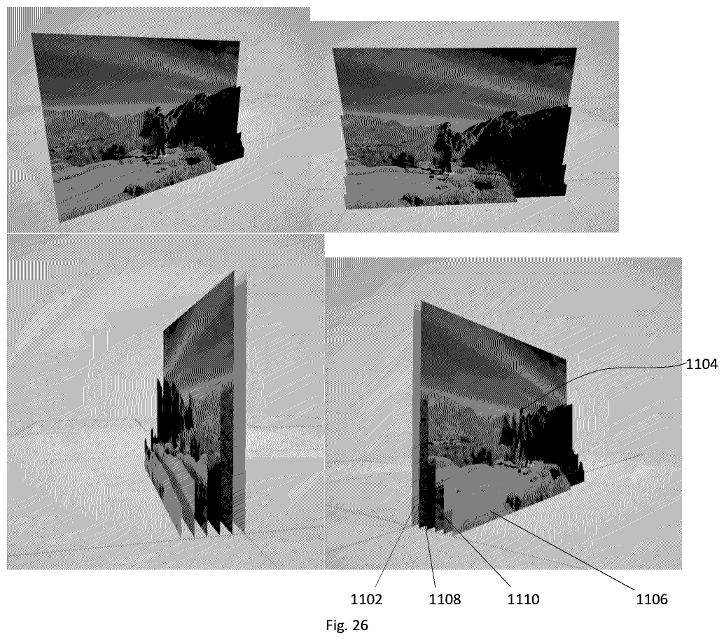

Various levels of segmentation may be employed, FIG. 24 is a two-layer segmentation of an original image 1100. FIG. 25 is a three-layer segmentation of the original image 1100. FIG. 26 is a five-layer segmentation of an original image.

Systems and methods disclosed herein allow users to take a photo/image and split it into multiple layers for rendering by way of, for example, printing, embossing or other means of affixing the same on physical media. There is thereby created a final product featuring a layered/depth effect including, in some embodiments, high resolution print or image rendering quality on multiple layers. The layers may be bound together or in fixed position using magnets/stands/frames, that may be clamped layers together, or other means of fixation or support to achieve the desired layered/depth or other effect (e.g., if there is a desire to highlight the prominence of a particular object in the original image). In some embodiments, layers may be configured and oriented with respect to one or more other ones of the layers to give the appearance of animation of the rendered imagery. In some such embodiments, the product may provide for selective movement of the layers each with respect to one or more others thereon.

At the core of the present disclosure is enhanced and assisted depth perception, permitting the nuanced ‘layering’ of 2D images into 3D renderings. FIGS. 6A-C are non-limiting examples of images, with depth analyses having been performed to illustrate potential layering of elements thereof. By way of comparison to existing devices and systems, it will be understood by one skilled in the art that prior designs do not exhibit the depth of field of multi-layer devices disclosed herein.

In some embodiments, rudimentary or assistive depth maps may be created from phone-or tablet-based cameras.

Some embodiments will provide for layer population and end product fabrication based on an inputted image depth map of an image. In such circumstances, the system may in some cases augment or enhance such map to facilitate better laying and quality of the end product.

Some depth maps may be created hereunder via use of stereo photos (e.g., two cameras with known positions).

[symbol]

Disclosed systems, methods, and apparatuses electronically assist users in determining what data to separate on which layers. The following features can work independently or in conjunction with each other. These systems and methods incorporate depth perception visualization and allow for detection of objects within an image. This detection aids perception of depth within an image by relative positioning of the objects (including, for example and without limitation, assessments of which and which portions of objects occlude others).

That is, irregularity of images may aid determinations of what is in fore-and background of an image. This facilitates isolation of a lone object and create or filling in of others based on disparity in depth on one object. The isolated object(s) may then be isolated from the remainder of the image—for example and without limitation, moving the isolated object to a foreground layer, with the remainder of the image being a background layer). By way of further and non-limiting example, detecting a sky in an image as an object and placing it as a background. This extrapolation of relative positioning may also be used to add stylistic elements to images (e.g., rain, birds, other airborne items). Such extrapolation may be employed in parallel with or, in some embodiments, in place of a depth map (showing, for example, relative positioning of shown articles to a ‘camera’ position. This facilitates an effective image editing, wherein there exists no requirement of fidelity to particulars of a source image.

Examples of image segmentation are shown in FIG. 3A, which may be compared to edge detection, shown in FIG. 3B.

As a subset of object detection in some embodiments, treatment of human facial features may require re-segmentation (e.g., using human parsing or facial recognition software). To determine if portions should be segmented. That is, in some embodiments, imagery such as FIG. 4 show a face from the front and wherein determinations may be made about relative location and proportion of elements thereof (e.g., from head on, nose is closer to viewer than lips, which is closer than eyes, which is closer than ears, etc.). For example, facial recognition aspects can combine with features described above to help determine layers to separate—that is, knowing what is an eye vs. a nose will allow for eyes to be initially placed on layers farther ‘back’ than those bearing the nose. This facilitates separation onto multiple layers for output.

There is also disclosed herein an option for in-painting for portions that are cut to forward layers-possibly to fill in back side of layers. That is, if a user takes a picture from the front of a human directly on, the back of the depicted person's head or, for example, would not be visible and are populated by the system. It will be appreciated by one skilled in the art that various features detailed herein may in some cases be offered each on their own and others in groups. Similarly, in-painting may address situations where a portion of something shown in an image is occluded by another articles shown therein (e.g., a human in front of a building), and the occluded content needs to be generated.

Systems disclosed herein provide in some embodiments for allow for manual correction and manual additions to images, etc. This may allow, for example, for addition of further layers beyond those present in a sourced image (e.g., to add image content for artistic or other purposes).

Some disclosed embodiments provide for users to input layer layouts with less steps required to reach completed layers (e.g., where such users have more sophistication; and wherein users are empowered to customize renditions of output via interactive visual media; this may include, for example and without limitation, on-screen or otherwise visible menus manipulable by the user to inform ultimate product layout and composition).

Embodiments disclosed herein permit display of layers prior to producing the final product in user-friendly ways compensating for any potential parallax views (e.g., via 3d model), including depending on the thickness of layer material and space between layers, to provide users with a meaningful proof of the end product to come.

Systems and methods herein disclosed address image decomposition to create depth with multiple layers along the Y axis (for example and without limitation, as contrasted with a 3-dimensional printer which can decompose and reproduce but on the Z axis (wherein Y is front to back, X is right to left, and Z is height in a three axis model) and then the entire image being recomposed.

In some embodiments, objects captured and decomposed are bound or unbound.

Embodiments disclosed herein may also incorporate assembled article creation, including, without limitation, layer population (using media such as, for example and without limitation, glass, acrylic or substantially transparent or translucent materials), with the layers to be positioned in the final product and, in some cases, fixed via means such as, for example, bonding or retained display of the layers at fixed distances determined in the creating process.

One skilled in the art will appreciate that while methods hereunder may be given to performance in different orders, any order will require an image file, irrespective of source. Further, various steps of processes disclosed herein may be performed in differing orders and combinations to achieve slightly different or somewhat similar effects by altering the order of the processes as well as the iterations of the processes.

For example, in embodiments seeking to exclude AI, FILL one may achieve a hollowed effect, as shown in FIG. 7, or an extruded effect, as shown in FIG. 8.

In some embodiments, a similar effect may be achieved whereby processing is conducted from closest layer to furthest layer (i.e., relative to viewer) manifesting as, for example, minor differences due to the infill having different content at different points in time (see, for example, FIG. 9).

FIG. 10 illustrates results of a content aware fill both on image and on depth map to predict when something should be printed on a given layer.

FIGS. 11A and 11B illustrate a model fully outlined and an in-process example with inpainting/infill on the depth map, respectively.

Articles created using systems and methods disclosed hereunder may be created from materials such as those discussed above, and optical crystal or other substrates which may or may not be substantially clear. In some embodiments, clouded or other textured or stylized substrates may be employed. In embodiments making use of non-clear substrates, cutting, for example via laser devices, may be required. Some embodiments may include alignment aids for use in aligning adjacent layers during assembly thereof into a finished article. In some such embodiments, outer edges of the assembled article would be covered and/or ground/shaved down to remove or remove from view such marks. In other embodiments, spacing aids may be provided to aid in placement of layers a desired distance from each other]

The substrate can be adhered together or placed in a stand or held together in a manner that accounts for the space between layers. In some such embodiments, separate layers may be provided mounted on a base (including by way of fasteners, adhesives).

The printed material can also be extremely thin and placed on a resign, then additional layers of resign can be poured with additional layers of image depth.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided as organizational cues. These headings shall not limit or characterize the invention(s) set out in any claims that may issue from this disclosure. Specifically, and by way of example, although the headings refer to a “Field” such claims should not be limited by the language under this heading to describe the so-called technical field. Further, a description of technology in the “Background” section is not to be construed as an admission that technology is prior art to any invention(s) in this disclosure. Neither is the “Brief Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least±1, 2, 3, 4, 5, 6, 7, 10, 12 or 15%.

The term “or combinations thereof” as used herein refers to all permutations and combinations of the listed items preceding the term. For example, “A, B, C, or combinations thereof is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims.

1. A method of image processing, the method comprising:
a. obtaining an original image (OI);
b. obtaining an image depth map (IDM);
c. posterizing the IDM where to a number of levels wherein the number is a final layer count (FLC);
d. splitting the IDM OR Object Detection image based on the FLC;
e. Clipping the OI into a plurality of clips based on the split IDM OR Object Detection image;
f. producing an infill/outfill between adjacent ones of the clips based on preceding clips in a production order;
g. determining a number of retained pixels;
h. printing each of the clips on a medium;

2. assembling the clips in an order.A method according to claim 1, further comprising converting the object detection to system scale.

3. A method according to claim 2, wherein the object detection comprises depictions of humans in the image in a first colour, background content in the image in a second colour and foreground content in a third colour.

4. A method according to claim 1, wherein the obtaining an image depth map (IDM) comprises generating an image depth map (IDM).

5. A method according to claim 4, further comprising converting the IDM to another coloring method that can be used to move consistently through the scale.

6. A method according to claim 5, wherein the method comprises greyscale.

7. A method according to claim 1, further comprising utilizing edge detection to identify and/or isolate one or more boundaries of one or more objects in the OI.

8. A method according to claim 1, further comprising utilizing object detecting to identify and/or isolate one or more objects in the OI.

9. A method according to claim 1, further comprising sharpening a resolution of the IDM.

10. A method according to claim 1, wherein the obtaining comprises input from a user.

11. A method according to claim 1, wherein the obtaining comprises retrieval from electronic storage media.

12. A method according to claim 1, wherein the obtaining comprises capturing the OI via an image capture device.

13. A method according to claim 12, wherein the image capture device comprises a digital camera.

14. A method according to claim 13, wherein the digital camera is integrated with a processing device.

15. A method according to claim 1, wherein the generating comprises extraction via the processing device; or, using an artificial intelligence system (AI) to create the IDM.

16. A method according to claim 1, wherein the FLC comprises in excess of 10 layers.

17. A method according to claim 15, wherein the FLC comprises in excess of 15 layers.

18. A method according to claim 1, wherein the FLC comprises more than 4 layers.

19. A method according to claim 1, wherein the FLC comprises more than 2 layers.

20. A method according to claim 1, wherein the FLC comprises 2 layers.

21. A method according to claim 20, wherein the producing is conducted via a further artificial intelligence processor.

22. A method according to claim 17, wherein the further artificial intelligence processor comprises the artificial intelligence processor.

23. A method according to claim 1, wherein the medium comprises one or more of glass, canvas, silicone, crystal.

24. Products produced according to the method of claim 1.

25. Systems for conducting methods according to claim 1.
